(19) United States
(12) Patent Application Publication
(10) Pub. No.: US 2025/0048368 A1
(43) Pub. Date: Feb. 6, 2025

(54) RANDOM ACCESS FOR ENHANCED UPLINK COVERAGE

(71) Applicant: Samsung Electronics Co., Ltd., Suwon-si (KR)

(72) Inventors: Shiyang Leng, Allen, TX (US); Anil Agiwal, McKinney, TX (US); Kyeongin Jeong, Allen, TX (US)

(21) Appl. No.: 18/780,363

(22) Filed: Jul. 22, 2024

Related U.S. Application Data
(60) Provisional application No. 63/530,819, filed on Aug. 4, 2023.
(60) Provisional application No. 63/539,721, filed on Sep. 21, 2023.

(51) Int. Cl. H04W 72/21; H04B 17/318; H04L 1/1812; H04W 72/51

(52) U.S. Cl. CPC H04W 72/21; H04B 17/328; H04L 1/1812; H04W 72/51

(57) ABSTRACT

Techniques for introducing Physical Uplink Control Channel (PUCCH) repetition capability for messages exchanged between a base station and UE are introduced. In an embodiment, a mechanism for introducing PUCCH repetition to a HARQ-ACK feedback may be employed by sending the indication request in an uplink allocation prior to the PUCCH repetition being configured for the UE's HARQ signals. In one example, a UE allocates a request for PUCCH repetition with Msg3 in a random access exchange, such that the base station can provide the HARQ feedback with its ensuing Msg4 communication using PUCCH repetition.

### CROSS-REFERENCE TO RELATED APPLICATIONS

This application claims the benefit of priority from U.S. Provisional Application No. 63/530,819 filed Aug. 4, 2023, and U.S. Provisional Application No. 63/539,721 filed Sep. 21, 2023, both entitled “RANDOM ACCESS FOR UPLINK COVERAGE” and both of which are expressly incorporated herein by reference in their entirety.

### TECHNICAL FIELD

This disclosure relates generally to a wireless communication system, and more particularly to, for example, but not limited to, random access for enhanced uplink coverage in wireless communication systems.

### BACKGROUND

Wireless communication devices, including but not limited to today's LTE and 5G NR systems and the 6G-styled technologies under current commercial development, are increasingly required to reliably support both a growing number of users and the expanding emergence of delay-sensitive and real-time applications. These applications include ultra-low latency applications, robotics, artificial intelligence (AI), cloud computing, unmanned vehicles, control systems, and the internet of things (IoT), to name a few.

One such technology historically crucial to fast-acquisition and reliable data exchanges includes the user equipment's (UE's) use of random access (RA) processes to establish uplink synchronization with a network. As bandwidth requirements continue to escalate, the reliance on RA has met with shortcomings. Particularly when network conditions are suboptimal, it can be difficult for the UE to reliably exchange messaging with the network to achieve initial synchronization or acquire critical data.

The description set forth in the background section should not be assumed to be prior art merely because it is set forth in the background section. The background section may describe aspects or embodiments of the present disclosure.

### SUMMARY

In one aspect of the disclosure, a user equipment (UE) is provided. The UE includes a transceiver configured to receive from a base station (BS) a configuration of physical uplink control channel (PUCCH) repetition for a Message 4 (Msg4) hybrid automatic repeat request (HARQ) feedback. The UE further includes a processor operably coupled to the transceiver. The processor is configured to determine if the UE is capable of PUCCH repetition for Msg4 HARQ feedback. Based on the determination that the UE is capable of PUCCH repetition for Msg4 HARQ feedback, the transceiver is configured to transmit, to the BS, a Message 3 (Msg3) Medium Access Control Packet Data Unit (MAC PDU). The Msg3 MAC PDU includes (i) a common control channel (CCCH) MAC Service Data Unit (SDU), and (ii) a MAC subheader including a logical channel identifier (LCID). A value of the LCID indicates the CCCH for PUCCH repetition for Msg 4 HARQ feedback.

In various embodiments, the configuration for PUCCH repetition for Msg4 HARQ feedback is received via a system information block (SIB). The configuration for PUCCH repetition for Msg4 HARQ feedback includes a reference signal received power (RSRP) threshold.

In various embodiments, the processor is further configured to determine whether a RSRP of a downlink (DL) path loss reference signal is smaller than the RSRP threshold. The Msg3 MAC PDU including the LCID value indicating the CCCH for PUCCH repetition for Msg4 HARQ feedback is transmitted based on the determination that the RSRP of the DL path loss reference signal is smaller than the RSRP threshold.

In various embodiments, the value of the LCID indicates a CCCH of size 48 bits or 64 bits for PUCCH repetition for Msg4 HARQ feedback, except for a reduced capability (RedCap) UE and an eRedCap UE.

In various embodiments, the value of the LCID indicates a CCCH of size 48 bits or 64 bits for a RedCap UE for PUCCH repetition for Msg4 HARQ feedback.

In various embodiments, the MAC subheader includes a one-bit field indicating whether the value of the LCID is from a first table of LCID values or a second table of LCID values

In various embodiments, the field is set to 0 to indicate that the value of the LCID is from the first table. The field is set to 1 to indicate that the value of the LCID is from the second table.

In various embodiments, the first table and the second table are each 64 bits in size.

In another aspect of the disclosure, a method performed by a user equipment (UE) is provided. The method includes receiving from a base station (BS) a configuration of physical uplink control channel (PUCCH) repetition for a Message 4 (Msg4) hybrid automatic repeat request (HARQ) feedback. The method further includes determining if the UE is capable of PUCCH repetition for Msg4 HARQ feedback. The method also includes transmitting to the BS, based on determining that the UE is capable of PUCCH repetition for Msg4 HARQ feedback, a Message 3 (Msg3) Medium Access Control Packet Data Unit (MAC PDU). The Msg3 MAC PDU includes (i) a common control channel (CCCH) MAC Service Data Unit (SDU), and (ii) a MAC subheader including a logical channel identifier (LCID). A value of the LCID indicates the CCCH for PUCCH repetition for Msg 4 HARQ feedback.

In various embodiments, the method further includes receiving the configuration for PUCCH repetition for Msg4 HARQ feedback via a system information block (SIB), and including in the configuration for PUCCH repetition for Msg4 HARQ feedback a reference signal received power (RSRP) threshold.

In various embodiments, the method further includes determining whether a RSRP of a downlink (DL) path loss reference signal is smaller than the RSRP threshold, and transmitting the Msg3 MAC PDU including the LCID value indicating the CCCH for PUCCH repetition for Msg4 HARQ feedback based on the determination that the RSRP of the DL path loss reference signal is smaller than the RSRP threshold.

In various embodiments, the value of the LCID indicates a CCCH of size 48 bits or 64 bits for PUCCH repetition for Msg4 HARQ feedback, except for a reduced capability (RedCap) UE and an eRedCap UE.

In various embodiments, the value of the LCID indicates a CCCH of size 48 bits or 64 bits for a RedCap UE for PUCCH repetition for Msg4 HARQ feedback.

In various embodiments, the value of the LCID indicates a CCCH of size 48 bits or 64 bits for an eRedCap UE for PUCCH repetition for Msg4 HARQ feedback.

In various embodiments, the method further provides including in the MAC subheader a one-bit field indicating whether the value of the LCID is from a first table of LCID values or a second table of LCID values. The method further includes setting the field to 0 to indicate that the value of the LCID is from the first table, and setting the field to 1 to indicate that the value of the LCID is from the second table.

In various embodiments, the first table and the second table are each 64 bits in size.

In another aspect of the disclosure, a base station (BS) is provided. The BS includes a processor, and a transceiver operably coupled to the processor. The transceiver is configured to transmit, to a user equipment (UE), a configuration of physical uplink control channel (PUCCH) repetition for a Message 4 (Msg4) hybrid automatic repeat request (HARQ) feedback. The transceiver is also configured to receive, from the UE, a Message 3 (Msg3) Medium Access Control Packet Data Unit (MAC PDU). The Msg3 MAC PDU includes (i) a common control channel (CCCH) MAC Service Data Unit (SDU), and (ii) a MAC subheader including a logical channel identifier (LCID), wherein a value of the LCID indicates the CCCH for PUCCH repetition for Msg 4 HARQ feedback.

In various embodiments, the transceiver is configured to receive from the UE Msg4 HARQ feedback based on the configuration of PUCCH repetition transmitted to the UE.

In various embodiments, the processor is configured to determine the configuration for PUCCH repetition for Msg4 HARQ feedback transmitted by the transceiver to the UE.

In various embodiments, the transceiver is configured to transmit to the UE a reference signal received power (RSRP) threshold in the configuration for PUCCH repetition for Msg4 HARQ feedback via a system information block (SIB).

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 is a signaling diagram between a BS and UE for an example four-step contention-based random access (CBRA) with a PUCCH repetition/request capability indication in Msg3, in accordance with an embodiment.

FIG. 5 is a signaling diagram between a BS and UE for an example Fallback CBRA with a PUCCH repetition request/capability indication in Mag3.

FIG. 6 is a signaling diagram between a BS and UE of a two-step CBRA random access procedure with a PUCCH repetition request/capability in Msg3.

FIG. 7 is an example MAC subheader field using a reserved bit and LCID extensions.

FIG. 8 is an example R/F/LCID/(eLCID)/L MAC subheader with an eight-bit L field.

FIG. 9 is an example R/F/LCID/(eLCID)/L MAC subheader with a 16-bit L field.

FIG. 10 is an example R/E/LCID MAC subheader.

FIG. 11 is an example R/E/F/LCID/(ELCID) MAC subheader with an eight-bit L field.

FIG. 12 is an example R/E/F/LCID/(ELCID)/L MAC subheader with a 16-bit L field.

FIG. 13 is an example field of an R/E/LCID MAC subheader in accordance with an embodiment.

FIG. 14 is an example flow diagram of a UE configuring itself with PUCCH repetition capability for use by the UE in Message 4 (Msg4) HARQ feedback, in accordance with an embodiment.

FIG. 15 is an example signaling diagram of a random access exchange between a UE and a BS, in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR (New Radio) systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. The key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHZ, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

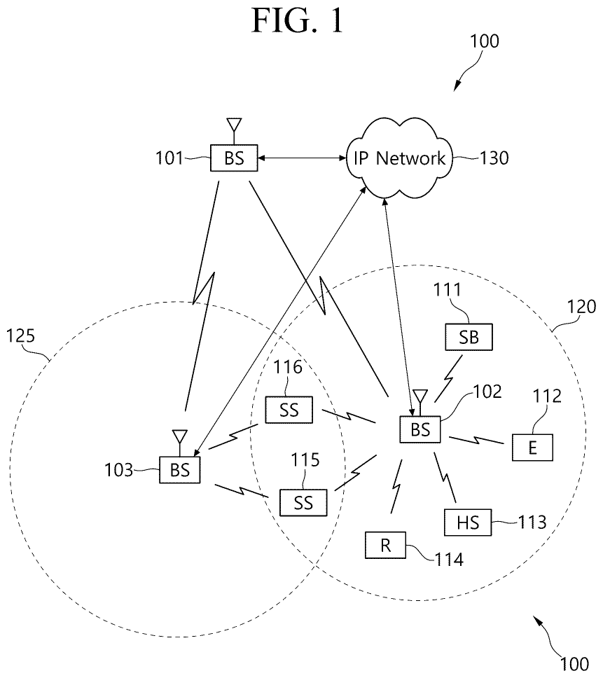

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101. For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor could support beamforming or directional routing operations in which outgoing signals from multiple antennas are weighted differently to effectively steer the outgoing signals in a desired direction. The controller/processor could also support OFDMA operations in which outgoing signals may be assigned to different subsets of subcarriers for different recipients (e.g., different UEs 111-114). Any of a wide variety of other functions could be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other devices or systems over a backhaul connection or over a network. The interface could support communications over any suitable wired or wireless connection(s). For example, the interface could allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory could include a RAM, and another part of the memory could include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

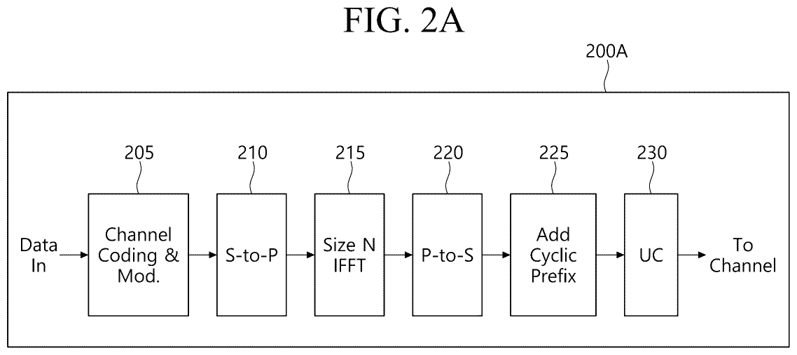

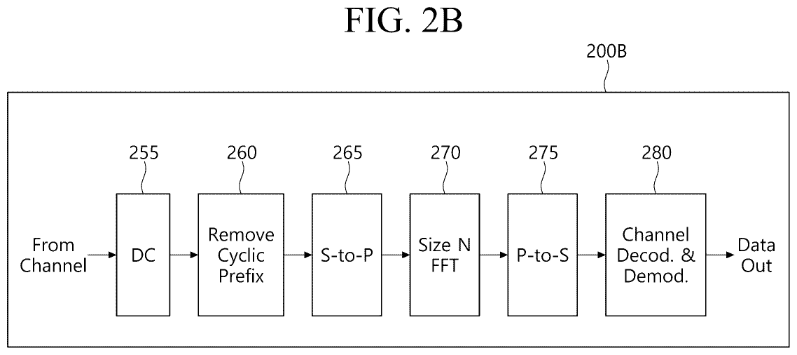

FIG. 2A shows an example of a wireless transmit path 200 in accordance with an embodiment. FIG. 2B shows an example of a wireless receive path 250 in accordance with an embodiment. In the following description, a transmit path 200 may be implemented in a gNB/BS (such as BS 102), while a receive path 250 may be implemented in a UE (such as UE 116). However, it will be understood that the receive path 250 can be implemented in a BS and that the transmit path 200 can be implemented in a UE. In some embodiments, the receive path 250 is configured to support the codebook design and structure for systems having 2D antenna arrays as described in embodiments of the present disclosure. That is to say, each of the BS and the UE each include transmit and receive paths such that duplex communication (such as a voice conversation) is made possible.

The transmit path 200 includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before it is transmitted, a parallel-to-serial (P-to-S) block 220 for serializing the block into a single datastream (noting that BSs/UEs with multiple transmit paths may each transmit a separate datastream), an add cyclic prefix block 225 for appending a guard interval that is a replica of the end part of the orthogonal frequency domain modulation (OFDM) symbol (or whatever modulation scheme is used) and is generally at least as long as the delay spread to mitigate effects of multipath propagation, and an up-converter (UC) 230 for modulating the baseband (or in some cases, intermediate frequency (IF)) signal onto the carrier signal to be used for transmission across an antenna. The receive path 250 essentially includes the opposite circuitry and includes a down-converter (DC) 255 for removing the datastream from the carrier signal, a remove cyclic prefix block 260 for removing the guard interval (or removing the interval of a different length), a serial-to-parallel (S-to-P) block 265 for taking the datastream and parallelizing it for faster operations, a size N Fast Fourier Transform (FFT) block 270 for converting the N time-domain signals to symbols in the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in the transmit path 200.

As a further example, in the transmit path 200, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), etc.) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memories. Each of the BSs 101-103 may implement a transmit path 200 that is analogous to transmitting in the downlink to UEs 111-116, Likewise, each of the BSs 101-103 may implement a receive path 250 that is analogous to receiving in the uplink from UEs 111-116. Similarly, to realize bidirectional signal execution, each of UEs 111-116 may implement a transmit path 200 for transmitting in the uplink to BSs 101-103 and each of UEs 111-116 may implement a receive path 250 for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

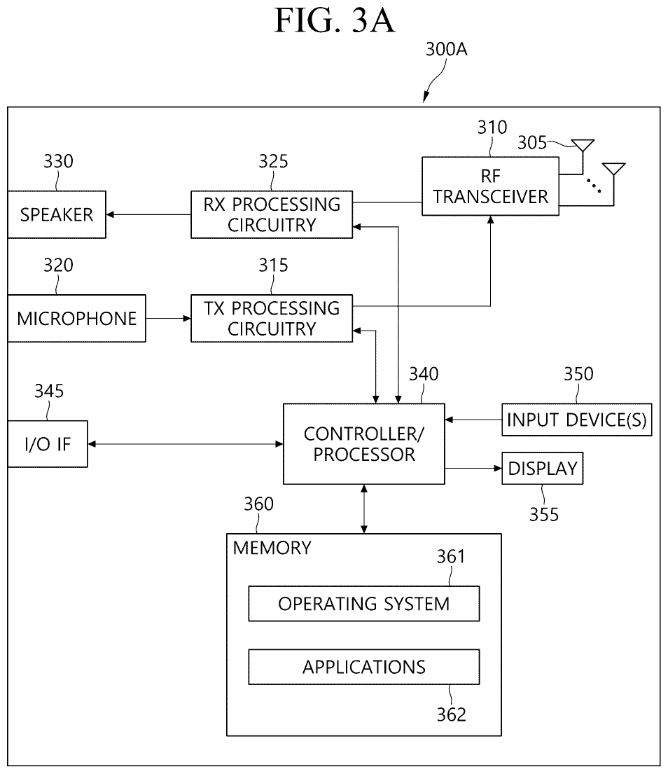

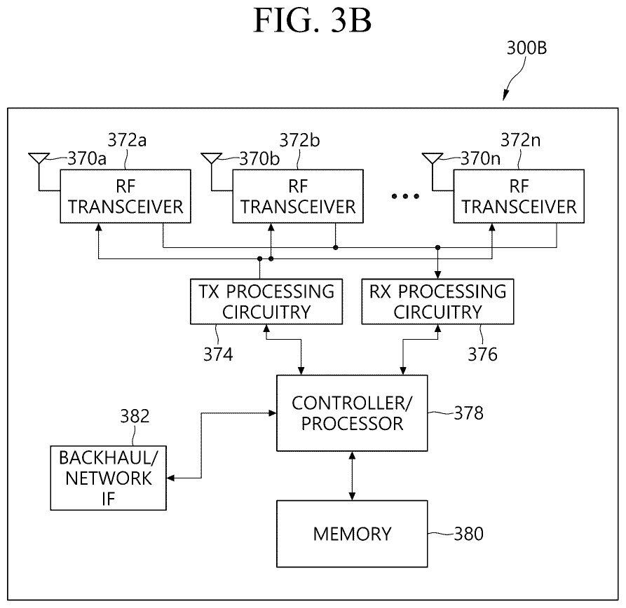

FIG. 3A shows an example of a user equipment (“UE”) 116 in accordance with an embodiment. It should be underscored that the embodiment of the UE 116 illustrated in FIG. 3A is for illustrative purposes only, and the UEs 111-115 of FIG. 1 can have the same or similar configuration. However, UEs come in a wide variety of configurations, and the UE 116 of FIG. 3A does not limit the scope of this disclosure to any particular implementation of a UE. Referring now to the components of FIG. 3A, the UE 116 includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 116 also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display may also constitute an input touchpad and in that case, it may be bidirectionally coupled with the processor 340.

The RF transceiver may include multiple physical components, depending on the sophistication and configuration of the UE. The RF transceiver 310 receives from antenna 305, an incoming RF signal transmitted by a BS of the network 100. The RF transceiver 310 thereupon down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The main processor 340 is also capable of executing other processes and programs resident in the memory 360, such as operations for supporting random access for enhanced uplink coverage in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. The main processor 340 is also coupled to the I/O interface 345, which provides the UE 116 with the ability to connect to other devices such as laptop computers and handheld computers. The I/O interface 345 is the communication path between these accessories and the main controller 340. The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 116 of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 116 may include separate processors, or they may be controlled in part or in full by firmware or middleware. For example, any one or more of the components of UE 116 may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 116 may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 116, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 102 in accordance with an embodiment. As noted, the terminology BS and gNB may be used interchangeably for purposes of this disclosure. The embodiment of the BS 102 shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. It is noted that BS 101 and BS 103 can include the same or similar structure as BS 102, or they may have different structures. As shown in FIG. 3B, the BS 102 includes multiple antennas 370a-370n, multiple corresponding RF transceivers 372a-372n, transmit (TX) processing circuitry 374, and receive (RX) processing circuitry 376. In certain embodiments, one or more of the multiple antennas 370a-370n include 2D antenna arrays. The BS 102 also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 102. For example, the processor 378 can control the reception of forward channel signals and the transmission of reverse channel signals by the RF transceivers 372a-372n, the RX processing circuitry 376, and the TX processing circuitry 374 in accordance with well-known principles. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 102 by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of executing programs and other processes resident in the memory 380, such as processes for supporting random access for enhanced uplink coverage in wireless communication systems as described in embodiments of the present disclosure. The processor 378 can move data into or out of the memory 380 as required by an executing process. A backhaul or network interface 382 allows the BS 102 to communicate with other devices or systems over a backhaul connection or over a network. The interface 382 can support communications over any suitable wired or wireless connection(s). For example, when the BS 102 is implemented as part of a cellular communication system (such as one supporting 5G, 5G-A, LTE, or LTE-A, etc.), the interface 382 can allow the BS 102 to communicate with other BSs over a wired or wireless backhaul connection. When the BS 102 is implemented as an access point, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of an BS 102, various changes may be made to FIG. 3B. For example, the BS 102 can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 102 can include multiple instances of each (such as one transmission or receive per RF transceiver).

As an example, Rel.13 LTE (cited below) supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel.14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 102 of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 102 may include separate processors, or they may be controlled in part or in full by firmware or middleware. For example, any one or more of the components of BS 102 may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 102 may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 102 was that of a structure on a tower, this depiction is exemplary only, and the BS may be present in other forms in accordance with well-known principles.

### REFERENCES

[1] 3GPP, TS 38.300 v17.5.0, 5G; NR; NR and NG-RAN Overall Description; Stage 2.
[2] 3GPP, TS 38.331 v17.5.0, 5G; NR; Radio Resource Control (RRC); Protocol Spec.
[3] 3GPP, TS 38.321 v17.5.0, NR; Medium Access Control (MAC) Protocol Spec.

### Abbreviations:

L1 Layer 1
L2 Layer 2
L3 Layer 3
UE User Equipment
gNB Base Station
NW Network
NR New Radio
3GPP 3rd Generation Partnership Project
WI Work Item
SI Study Item
HO Handover
CHO Conditional Handover
DAPS Dual Active Protocol Stack
BFD Beam Failure Detection
BFR Beam Failure Recovery
SSB System Synchronization Block
CSI Channel State Information
RS Reference Signal
TRP Transmit/Receive Point
SpCell Special Cell
SCell Secondary Cell
HARQ Hybrid ARQ
NDI New Data Indication
RRC Radio Resource Control
DU Distributed Unit
CU Central Unit
C-RNTI Cell Radio Network Temporary Identifier
CS-RNTI Configured Scheduling Radio Network Temporary Identifier
SPS Semi-Persistent Scheduling
SR Scheduling Request
UL-SCH Uplink Shared Channel
LCP Logical Channel Prioritization
PDU Protocol Data Unit
RSRP Reference Signal Received Power
SINR Signal to Interference and Noise Ratio
BLER Block Error Rate
CQI Channel Quality Indicator
TA Timing Advance
MIB Master Information Block
SIB System Information Block
CORESET Control Resource Set
RAR Random Access Response
DL Downlink
UL Uplink
DCI Downlink Control Information
PDCCH Physical Downlink Control Channel
PUSCH Physical Uplink Shared Channel
PUCCH Physical Uplink Control Channel
PUSCH Physical Downlink Shared Channel
SRS Sounding Reference Signal
PRACH Physical Random Access Channel
IE Information Element
TCI Transmission Configuration Indicator
RA Random Access

To enable PUCCH repetition for Msg4 HARQ feedback (e.g., HARQ-ACK), signalling of UE capability and/or repetition request is needed before Msg4. Thus, the RA procedure that enables PUCCH repetition for Msg4 HARQ feedback is desired to be specified. Accordingly, in an aspect of the present disclosure, the relevant signalling in RA procedures is provided for enabling PUCCH repetition for Msg4 HARQ feedback.

For the Random Access (RA) procedure, Msg4/MsgB is transmitted by the NW for contention resolution and UE sends Msg4/MsgB HARQ feedback to acknowledge the contention resolution. To transmit the Msg4/MsgB HARQ feedback reliably, PUCCH repetition can be used to increase the reliability of NW receiving Msg4/MsgB HARQ feedback.

For random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

The network can associate a set of RACH resources with feature(s) applicable to a Random Access procedure: Network Slicing, RedCap, SDT, and NR coverage enhancement. A set of RACH resources associated with a feature is only valid for random access procedures applicable to at least that feature; and a set of RACH resources associated with several features is only valid for random access procedures having at least all these features. The UE selects the set(s) of applicable RACH resources, after uplink carrier (i.e. NUL or SUL) and BWP selection and before selecting the RA type.

Two types of random access procedure are supported: 4-step RA type with MSG1 and 2-step RA type with MSGA. Both types of RA procedure support contention-based random access (CBRA) and contention-free random access (CFRA). The UE selects the type of random access at initiation of the random access procedure based on network configuration:
(1) when CFRA resources are not configured, an RSRP threshold is used by the UE to select between 2-step RA type and 4-step RA type;
(2) when CFRA resources for 4-step RA type are configured, UE performs random access with 4-step RA type;
(3) when CFRA resources for 2-step RA type are configured, UE performs random access with 2-step RA type.

The network does not configure CFRA resources for 4-step and 2-step RA types at the same time for a Bandwidth Part (BWP). CFRA with 2-step RA type is only supported for handover. The MSG1 of the 4-step RA type consists of a preamble on PRACH. After MSG1 transmission, the UE monitors for a response from the network within a configured window. For CFRA, a dedicated preamble for MSG1 transmission is assigned by the network and upon receiving random access response from the network, the UE ends the random access procedure. For CBRA, upon reception of the random access response, the UE sends MSG3 using the UL grant scheduled in the response and monitors contention resolution. If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resources are configured for MSGA transmission and upon receiving the network response, the UE ends the random access procedure. For CBRA, if contention resolution is successful upon receiving the network response, the UE ends the random access procedure; while if fallback indication is received in MSGB, the UE performs MSG3 transmission using the UL grant scheduled in the fallback indication and monitors contention resolution. If contention resolution is not successful after MSG3 (re)transmission(s), the UE reverts to MSGA transmission.

If the random access procedure with 2-step RA type is not completed after a number of MsgA transmissions, the UE can be configured to switch to CBRA with 4-step RA type.

Regarding the signalling, if UE is capable of PUCCH repetition, UE needs to send a capability indication before Msg4 so that the resource for PUCCH repetition for Msg4 HARQ feedback can be assigned by the NW; if UE is capable of PUCCH repetition and requests PUCCH repetition for Msg4 HARQ feedback due to poor channel condition, UE needs to send a repetition request indication before Msg4. Multiple approaches of signalling the PUCCH repetition request/capability are feasible. In one embodiment, the request/capability indication of PUCCH repetition for Msg4 HARQ feedback can be included in Msg3/MsgA. In the following, the repetition request/capability indication is used to refer PUCCH repetition for Msg4 HARQ-ACK.

In Msg3/MsgA, the repetition request/capability indication can be conveyed in different ways. As a first example, the 1st or 2nd Reserved bit in MAC subheader of UL CCCH MAC SDU in Msg3/MsgA setting to one indicates the repetition request/capability. As a second example, the 1st or 2nd Reserved bit in the MAC subheader of C-RNTI MAC CE in Msg3/MsgA setting to one indicates the repetition request/capability. Other examples are replete. A new LCID, denoted A, for instance, may be used to identify a UL CCCH MAC SDU of size 48 bits in Msg3/MsgA sent by a RedCap UE indicating repetition request/capability. Similarly, a new LCID, denoted B, may be used to identify a UL CCCH MAC SDU of size 64 bits in Msg3/MsgA sent by a RedCap UE indicating repetition request/capability. A new LCID denoted C may likewise be used to identify a UL CCCH MAC SDU of size 48 bits in Msg3/MsgA sent by a non-RedCap UE indicating repetition request/capability. A new LCID, denoted D, may be used to identify a UL CCCH MAC SDU of size 64 bits in Msg3/MsgA sent by a non-RedCap UE indicating repetition request/capability.

A new MAC CE, named PUCCH repetition request/capability MAC CE, indicates the repetition request/capability, where the MAC CE is of fixed size with zero bits and identified by a LCID or an eLCID. For logical channels prioritization, MAC CE for PUCCH repetition request/capability can be transmitted with higher or lower or same prioritization as MAC CE for Timing Advance Report. Still a new LCID, denoted E, may be used to identify a UL CCCH MAC SDU of size 48 bits in Msg3/MsgA sent by an eRedCap UE indicating repetition request/capability. A new LCID, denoted F, is used to identify a UL CCCH MAC SDU of size 64 bits in Msg3/MsgA sent by an eRedCap UE indicating repetition request/capability.

Below is a summary of the aforedescribed ways in which the repetition request/capability can be sent in Msg3/MsgA:
1. The 1st or 2nd Reserved bit in the MAC subheader of UL CCCH MAC SDU in Msg3/MsgA setting to 1 indicates the repetition request/capability.
2. The 1^{st} or 2^{nd} Reserved bit in the MAC subheader of C-RNTI MAC CE in Msg3/MsgA setting to 1 indicates the repetition request/capability.
3. A new LCID, denoted A, is used to identify a UL CCCH MAC SDU of size 48 bits in Msg3/MsgA sent by a RedCap UE indicating repetition request/capability.
4. A new LCID, denoted B, is used to identify a UL CCCH MAC SDU of size 64 bits in Msg3/MsgA sent by a RedCap UE indicating repetition request/capability.
5. A new LCID, denoted C, is used to identify a UL CCCH MAC SDU of size 48 bits in Msg3/MsgA sent by a non-RedCap UE indicating repetition request/capability.
6. A new LCID, denoted D, is used to identify a UL CCCH MAC SDU of size 64 bits in Msg3/MsgA sent by a non-RedCap UE indicating repetition request/capability.
7. A new MAC CE, named PUCCH repetition request/capability MAC CE, indicates the repetition request/capability, where the MAC CE is of fixed size with zero bits and identified by a LCID or an eLCID. For logical channels prioritization, MAC CE for PUCCH repetition request/capability can be transmitted with higher or lower or same prioritization as MAC CE for Timing Advance Report.
8. A new LCID, denoted E, is used to identify a UL CCCH MAC SDU of size 48 bits in Msg3/MsgA sent by an eRedCap UE indicating repetition request/capability.
9. A new LCID, denoted F, is used to identify a UL CCCH MAC SDU of size 64 bits in Msg3/MsgA sent by an eRedCap UE indicating repetition request/capability.

For examples 1 and 2 set forth above, the Reserved bit setting to 0 may be used to indicate that the device is not requesting/capable of PDCCU repetition for Msg4 HARQ feedback. For example, 3, 4, 5, 6, 8, 9 using the existing LCIDs for UL CCCH MAC SDU of size 48 or 64 bits in Msg3/MsgA for a RedCap or an eRedCap or a non-RedCap UE indicate not requesting/capable of PDCCU repetition for Msg4 HARQ feedback. The existing LCIDs (i.e., X, X1, Y, Y1, X2, Y2) and new LCIDs (A, B, C, D, E, F) are listed in the table below.

TABLE 1
LCIDs for UL CCCH MAC SDU

| LCID | Interpretation of the LCID |
|---|---|
| 35 (X1) | CCCH of size 48 bits (referred to as “CCCH” in TS 38.331 [2]) for a RedCap UE |
| 36 (Y1) | CCCH of size 64 bits (referred to as “CCCH1” in TS 38.331 [2]) for a RedCap UE |
| 52 (X) | CCCH of size 48 bits (referred to as “CCCH” in TS 38.331 [2]), except for a |
| | RedCap UE |
| 0 (Y) | CCCH of size 64 bits (referred to as “CCCH1” in TS 38.331 [2]), except for a |
| | RedCap UE |
| X2 | CCCH of size 48 bits (referred to as “CCCH” in TS 38.331 [2]) for an eRedCap UE |
| Y2 | CCCH of size 64 bits (referred to as “CCCH1” in TS 38.331 [2]) for an eRedCap |
| | UE |
| A | CCCH of size 48 bits (referred to as “CCCH” in TS 38.331 [2]) for a RedCap UE |
| | indicating repetition request/capability |
| B | CCCH of size 64 bits (referred to as “CCCH1” in TS 38.331 [2]) for a RedCap UE |
| | indicating repetition request/capability |
| C | CCCH of size 48 bits (referred to as “CCCH” in TS 38.331 [2]), except for RedCap |
| | UE and eRedCap UE, indicating repetition request/capability |
| D | CCCH of size 64 bits (referred to as “CCCH1” in TS 38.331 [2]), except for RedCap |
| | UE and eRedCap UE, indicating repetition request/capability |
| E | CCCH of size 48 bits (referred to as “CCCH” in TS 38.331 [2]) for an eRedCap |
| | UE, indicating repetition request/capability |
| F | CCCH of size 64 bits (referred to as “CCCH1” in TS 38.331 [2]) for an eRedCap |
| | UE, indicating repetition request/capability |

Because the new request/capability indications of PUCCH repetition in the charts for Msg4 HARQ feedback is sent to the NW before Msg4, UE behavior in RA procedure is impacted. Accordingly, in an embodiment this behavior is specified more thoroughly specified for the case in which UE and gNB support PUCCH repetition for Msg4 HARQ feedback. the RA procedure is described as follows.

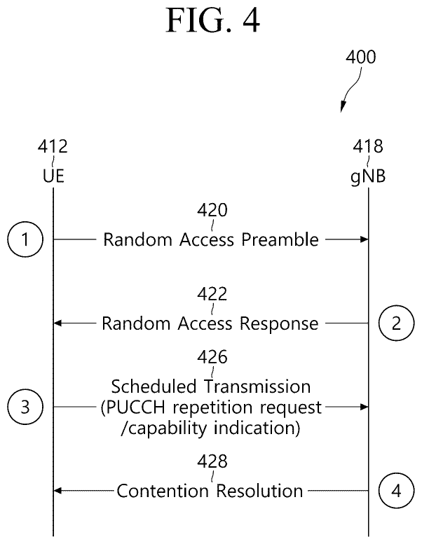

FIG. 4 is a signaling diagram 400 for an example four-step contention-based random access (CBRA) with a PUCCH repetition/request capability indication in Msg3, in accordance with an embodiment. FIG. 4 includes UE 412 and gNB 418. It will be understood that UE 412 may be many different kinds of devices, including, for example, a mobile device, a personal computer, a laptop computer, a table computer, or virtually any type of device, present or future, that can maintain a cellular connection. Similarly, while gNB 418 is a 5G network base station, for purposes of inclusion, the gNB may also be referred to as a base station, eNodeB, or any type of centralized hardware infrastructure that includes or incorporates the functions and features of a base station.

Referring to the diagram 400 at hand, it was noted that the diagram pertained to a four-step CBRA implementation. Accordingly, at 420, the UE 412 transmits a preamble over a random access channel. Thereupon, at 422, UE 412 receives a random access response (RAR) which includes the uplink grant to the UE for sending Msg3. At 426, UE 412 consequently transmits the UL grant using a MAC packet data unit (PDU) to populate the resources granted by gNB 418.

In one aspect of the disclosure, for the procedure at 426 the UE transmits the Msg3 MAC PDU using the uplink (UL) grant. That is, for this Msg3 transmission of this embodiment, the indication by the UE of its PUCCH repetition request capability can be included in Msg3, which is importantly before contention resolution at 428. The following embodiments can serve as one illustration concerning how this procedure is formed.

If the cell radio network temporary identifier (C-RNTI) of the MAC CE is included in Msg3 MAC PDU:
1^{st} or 2^{nd} R bit in MAC subheader of C-RNTI MAC CE in Msg3 MAC PDU is set to 1 to indicate repetition request/capability, or
1^{st} or 2^{nd} R bit in MAC subheader of C-RNTI MAC CE in Msg3 MAC PDU is set to 0 to not indicate repetition request/capability.

In this case, if repetition request capability is desired, the UE will set the first or second R bit in the MAC subheader of C-RNTI MAC CE in Msg3 MAC PDU.

If UL CCCH MAC SDU is included in Msg3 MAC PDU, this leads to different embodiments for indicating the PUUCH repetition request/capability, e.g.:
1. 1^{st} or 2^{nd} R bit in MAC subheader of UL CCCH MAC SDU in Msg3 MAC PDU is set to 1 to indicate repetition request/capability; or
2. 1^{st} or 2^{nd} R bit in MAC subheader of UL CCCH MAC SDU in Msg3 MAC PDU is set to 0 to not indicate repetition request/capability; or
3. LCID in MAC subheader is set to A/B/C/D/E/F for CCCH MAC SDU in Msg3 MAC PDU respectively to indicate repetition request/capability; or
4. LCID in MAC subheader is set to X/Y/X1/Y1/X2/Y2 for CCCH MAC SDU in Msg3 MAC PDU respectively to not indicate repetition request/capability.

As an example, the indication of PUCCH repetition request/capability is included in Msg3 if this is the random access (RA) for initial access or if UE is configured to indicate PUCCH repetition request/capability in RA.

In another embodiment directed to Msg3 transmissions such as shown in FIG. 4, if a threshold is configured for PUCCH repetition of Msg3 HARQ feedback, the threshold is used to determine whether the indication of PUCCH repetition request/capability is included in Msg3 or not. The threshold can be signaled per RACH configuration, per bandwidth part (BWP), per cell in the system information block (SIB), or in an RRCReconfiguration message.

If the cell radio network temporary identifier (C-RNTI) MAC CE is included in Msg3 MAC PDU and the downlink (DL) signal quality (or RSRP of path loss reference) is <threshold:
1^{st} or 2^{nd} R bit in MAC subheader of C-RNTI MAC CE in Msg3 MAC PDU is set to 1 to indicate repetition request/capability

Else if C-RNTI MAC CE is included in Msg3 MAC PDU and downlink signal quality (or RSRP of path loss reference) is >=threshold:
1^{st} or 2^{nd} R bit in MAC subheader of C-RNTI MAC CE in Msg3 MAC PDU is set to 0 to not indicate repetition request/capability.

If UL CCCH MAC SDU is included in Msg3 MAC PDU and downlink signal quality (or RSRP of path loss reference) is <threshold:
1^{st} or 2^{nd} R bit in MAC subheader of UL CCCH MAC SDU in Msg3 MAC PDU is set to 1 to indicate repetition request/capability, or
LCID in MAC subheader is set to A/B/C/D/E/F for CCCH MAC SDU in Msg3 MAC PDU respectively to indicate repetition request/capability;

Else if UL CCCH MAC SDU is included in Msg3 MAC PDU and downlink signal quality (or RSRP of path loss reference) is >=threshold:
1^{st} and 2^{nd} R bit in MAC subheader of UL CCCH MAC SDU in Msg3 MAC PDU is set to 0 to not indicate repetition request/capability, or
LCID in MAC subheader is set to X/Y/X1/Y1/X2/Y2 for CCCH MAC SDU in Msg3 MAC PDU respectively to not indicate repetition request/capability.

In various embodiments, for Msg3 transmissions, the PUCCH repetition request/capability MAC CE is used to indicate the PUCCH repetition request/capability. For instance, if UE 412 requests or is capable of PUCCH repetition, the PUCCH repetition request/capability MAC CE and its MAC subheader are included in the Msg3 MAC PDU. In a further embodiment, the PUCCH repetition request/capability MAC CE and its MAC subheader are included in Msg3 MAC PDU if this is RA for initial access, or if UE is configured to indicate PUCCH repetition request/capability in RA or if a threshold is configured for PUCCH repetition of Msg3 HARQ feedback and the downlink signal quality (or RSRP of path loss reference) is smaller than the configured threshold.

Thereafter, as noted above, after the Msg3 transmission at 426, then UE receives Msg4 at 428. In the Msg4, network may indicate PUCCH repetitions for HARQ feedback of Msg4 based on whether the indication of PUCCH repetition request/capability is included in Msg3 or not. If the indication of PUCCH repetitions for HARQ feedback of Msg4 is included in Msg4, UE sends PUCCH repetitions for HARQ feedback of Msg4.

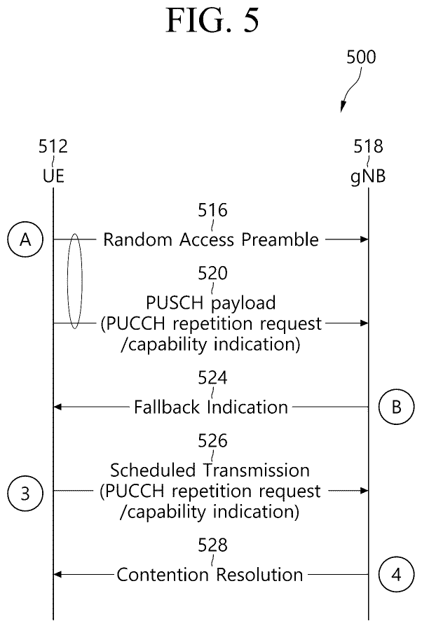

In another aspect of the disclosure, “Fallback” CBRA with PUCCH repetition request/capability may be implemented. FIG. 5 is a signaling diagram 500 between a BS (gNB) 518 and UE 512 for an example Fallback CBRA with a PUCCH repetition request/capability indication in Mag3. FIG. 5 illustrates an example procedure of fallback CBRA with PUCCH repetition request/capability indication in Msg3, in accordance with an embodiment.

For MsgA MAC PDU transmission, in one embodiment, the indication of PUCCH repetition request/capability can be included in MsgA MAC PDU, as represented by the RA preamble transmission 516 and the PUSCH payload with the PUCCH repetition request/capability indication 524, collectively.

If C-RNTI MAC CE is included in MsgA MAC PDU:
1^{st} or 2^{nd} R bit in MAC subheader of C-RNTI MAC CE in MsgA MAC PDU is set to 1 to indicate repetition request/capability; or
1^{st} or 2^{nd} R bit in MAC subheader of C-RNTI MAC CE in MsgA MAC PDU is set to 0 to not indicate repetition request/capability.

If UL CCCH MAC SDU is included in MsgA MAC PDU:
1. 1^{st} or 2^{nd} R bit in MAC subheader of UL CCCH MAC SDU in MsgA MAC PDU is set to 1 to indicate repetition request/capability; or
2. 1^{st} or 2^{nd} R bit in MAC subheader of UL CCCH MAC SDU in MsgA MAC PDU is set to 0 to not indicate repetition request/capability; or
3. LCID in MAC subheader is set to A/B/C/D/E/F for CCCH MAC SDU in MsgA MAC PDU respectively to indicate repetition request/capability; or
4. LCID in MAC subheader is set to X/Y/X1/Y1/X2/Y2 for CCCH MAC SDU in MsgA MAC PDU respectively to not indicate repetition request/capability;

As an example, the indication of PUCCH repetition request/capability is included in MsgA MAC PDU if this is RA for initial access or if UE is configured to indicate PUCCH repetition request/capability in RA.

In a further embodiment relating to MsgA MAC PDU transmission, if a threshold is configured for PUCCH repetition of MsgB/Msg4 HARQ feedback, the threshold may be used to determine whether the indication of PUCCH repetition request/capability is included in MsgA or not. The threshold can be signaled per RACH configuration, per BWP or per Cell in SIB or in RRCReconfiguration message. This embodiment is illustrated by the following example routine, below.

If C-RNTI MAC CE is included in MsgA MAC PDU and downlink signal quality (or RSRP of path loss reference) is <threshold:
1^{st} or 2^{nd} R bit in MAC subheader of C-RNTI MAC CE in MsgA MAC PDU is set to 1 to indicate repetition request/capability;

Else if C-RNTI MAC CE is included in MsgA MAC PDU and downlink signal quality (or RSRP of path loss reference) is >=threshold:
1^{st} or 2^{nd} R bit in MAC subheader of C-RNTI MAC CE in MsgA MAC PDU is set to 0 to not indicate repetition request/capability.

If UL CCCH MAC SDU is included in MsgA MAC PDU and downlink signal quality (or RSRP of path loss reference) is <threshold:
1^{st} or 2^{nd} R bit in MAC subheader of UL CCCH MAC SDU in MsgA MAC PDU is set to 1 to indicate repetition request/capability, or
LCID in MAC subheader is set to A/B/C/D/E/F for CCCH MAC SDU in MsgA MAC PDU respectively to indicate repetition request/capability;

Else if UL CCCH MAC SDU is included in MsgA MAC PDU and downlink signal quality (or RSRP of path loss reference) is >=threshold:
1^{st} and 2^{nd} R bit in MAC subheader of UL CCCH MAC SDU in MsgA MAC PDU is set to 0 to not indicate repetition request/capability, or
LCID in MAC subheader is set to X/Y/X1/Y1/X2/Y2 for UL CCCH MAC SDU in MsgA MAC PDU respectively to not indicate repetition request/capability.

For MsgA MAC PDU, in various embodiments, the PUCCH repetition request/capability MAC CE is used at 516 to indicates the PUCCH repetition request/capability. For instance, if UE requests or is capable of PUCCH repetition, the PUCCH repetition request/capability MAC CE and its MAC subheader are included in the MsgA MAC PDU. As one more example, the PUCCH repetition request/capability MAC CE and its MAC subheader are included in MsgA MAC PDU if this is RA for initial access or if UE is configured to indicate PUCCH repetition request/capability in RA or if a threshold is configured for PUCCH repetition of MsgB/Msg4 HARQ feedback and the downlink signal quality (or RSRP of path loss reference) is smaller than the configured threshold.

Following the MsgA transmission, UE 512 receives MsgB. If UE receives MsgB including fallback RAR and UL grant for Msg3, UE transmits MsgA MAC PDU in Msg3 using the UL grant. In the Msg4, network may indicate PUCCH repetitions for HARQ feedback of Msg4 based on whether the indication of PUCCH repetition request/capability is included in Msg3 or not, such as in 520. If UE receives Msg4 and the indication of PUCCH repetitions for HARQ feedback of Msg4 is included in Msg4 such as at 526, UE sends PUCCH repetitions for HARQ feedback of Msg4. At 528, BS may send a contention resolution message.

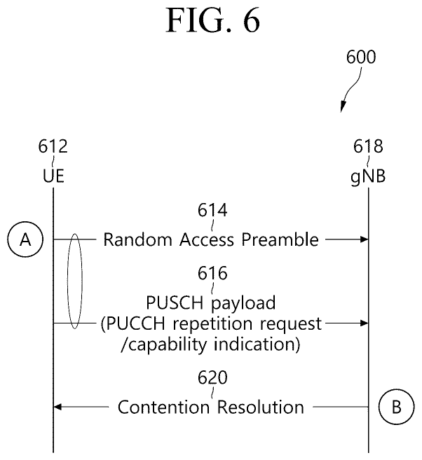

In other procedures, a UE may transmit the MsgA RA preamble together with the MsgA PUSCH payload including the MAC PDU. To that end, FIG. 6 is a signaling diagram 600 between a BS (gNB 618) and UE 612 of a two-step CBRA random access procedure with a PUCCH repetition request/capability in Msg3. As in previous embodiments, a UE 612 interacts with gNB 618. Here, however, latency can be lowered due to the decreased number of operations, but at the potential balancing of latency with a greater possibility of collisions. For the procedure in FIG. 6, UE 612 transmits both an MsgA preamble at 614 and MsgA PUSCH payload at 616, as shown by the following example routines and the circle encompassing the initial transmissions 614 and 616. The gNB 618 may respond at 620 with contention resolution.

In a first embodiment of MsgA MAC PDU transmission, the indication of PUCCH repetition request/capability can be included in MsgA MAC PDU, as set forth in the example routine below.

If C-RNTI MAC CE is included in MsgA MAC PDU:
1^{st} or 2^{nd} R bit in MAC subheader of C-RNTI MAC CE in MsgA MAC PDU is set to 1 to indicate repetition request/capability; or
1^{st} or 2^{nd} R bit in MAC subheader of C-RNTI MAC CE in MsgA MAC PDU is set to 0 to not indicate repetition request/capability.

If UL CCCH MAC SDU is included in MsgA MAC PDU:
1^{st} or 2^{nd} R bit in MAC subheader of UL CCCH MAC SDU in MsgA MAC PDU is set to 1 to indicate repetition request/capability; or
1^{st} or 2^{nd} R bit in MAC subheader of UL CCCH MAC SDU in MsgA MAC PDU is set to 0 to not indicate repetition request/capability; or
LCID in MAC subheader is set to A/B/C/D/E/F for UL CCCH MAC SDU in MsgA MAC PDU respectively to indicate repetition request/capability; or
LCID in MAC subheader is set to X/Y/X1/Y1/X2/Y2 for UL CCCH MAC SDU in MsgA MAC PDU respectively to not indicate repetition request/capability

In a second embodiment of MsgA MAC PDU transmission, if a threshold is configured for PUCCH repetition of MsgB/Msg4 HARQ feedback, the threshold is used to determine whether the indication of PUCCH repetition request/capability is included in MsgA or not. The threshold can be signaled per RACH configuration, per BWP, or per Cell in SIB or in an RRCReconfiguration message, as in the following example routine.

If C-RNTI MAC CE is included in MsgA MAC PDU and downlink signal quality (or RSRP of path loss reference) is <threshold:
1^{st} or 2^{nd} R bit in MAC subheader of C-RNTI MAC CE in MsgA MAC PDU is set to 1 to indicate repetition request/capability;
Else if C-RNTI MAC CE is included in MsgA MAC PDU and downlink signal quality (or RSRP of path loss reference) is >=threshold:
1^{st} or 2^{nd} R bit in MAC subheader of C-RNTI MAC CE in MsgA MAC PDU is set to 0 to not indicate repetition request/capability.

If UL CCCH MAC SDU is included in MsgA MAC PDU and downlink signal quality (or RSRP of path loss reference) is <threshold:
1^{st} or 2^{nd} R bit in MAC subheader of UL CCCH MAC SDU in MsgA MAC PDU is set to 1 to indicate repetition request/capability, or
LCID in MAC subheader is set to A/B/C/D/E/F for UL CCCH MAC SDU in MsgA MAC PDU respectively to indicate repetition request/capability;

Else if UL CCCH MAC SDU is included in MsgA MAC PDU and downlink signal quality (or RSRP of path loss reference) is >=threshold:
1^{st} and 2^{nd} R bit in MAC subheader of UL CCCH MAC SDU in MsgA MAC PDU is set to 0 to not indicate repetition request/capability, or
LCID in MAC subheader is set to X/Y/X1/Y1/X2/Y2 for UL CCCH MAC SDU in MsgA MAC PDU respectively to not indicate repetition request/capability.

Accordingly, in one or more embodiments corresponding to MsgA MAC PDU, the PUCCH repetition request/capability MAC CE may be used to indicate the PUCCH repetition request/capability. For instance, if UE requests or is capable of PUCCH repetition, the PUCCH repetition request/capability MAC CE and its MAC subheader are included in the MsgA MAC PDU. As another example, the PUCCH repetition request/capability MAC CE and its MAC subheader are included in MsgA MAC PDU if this is RA for any of an initial access, if UE is configured to indicate PUCCH repetition request/capability in RA, or if a threshold is configured for PUCCH repetition of MsgB/Msg4 HARQ feedback and the downlink signal quality (or RSRP of path loss reference) is smaller than the configured threshold.

With continued reference to FIG. 6, after MsgA transmission, UE receives MsgB including success RAR. In the MsgB, network may indicate PUCCH repetitions for HARQ feedback of MsgB based on whether the indication of PUCCH repetition request/capability is included in MsgA or not. If the indication of PUCCH repetitions for HARQ feedback of MsgB is included in MsgB, UE sends PUCCH repetitions for HARQ feedback of MsgB.

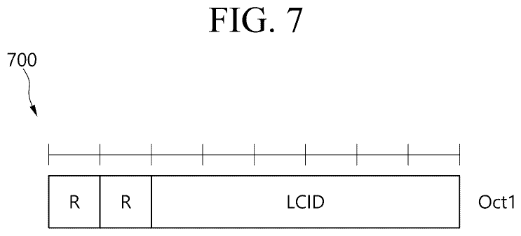

In another aspect of the disclosure, an R bit (reserved bit) may be used in a MAC PDU subheader in order to effect LCID extension. FIG. 7 is an example MAC subheader field 700 using a reserved bit and LCID extensions. As shown by the vernacular “Oct1,” the sizing of the subheader is an octet in length, which is eight bits. In the embodiment shown, an R (“reserved”) bit can be used for an LCID extension. “LCID” constitutes the logical channel identifiers. An LCID constitutes the logical channel ID field that identifies the logical channel instance of the corresponding MAC Service Data Unit (SDU) or the type of the corresponding MAC CE or padding for the DL-SCH and UP-SCH channels, respectively. As seen in FIG. 7, there is one LCID per subheader. Since each R bit is one bit, the size of the LCID field is six bits. In short, in a MAC subheader as shown, 6 bits are used to indicate the existing 64 LCIDs for DL-SCH or UL-SCH, since the quantity 2⁶=64. A single R bit can be used to indicate another 64 LCIDs or 128 total LCIDs (2⁷=128).

With continued reference to FIG. 7, in an embodiment as noted, one of the reserved bits in the MAC subheader in a MAC PDU can be used for the requisite LCID extension. Other suitable variations are possible without departing from the scope of the present disclosure.

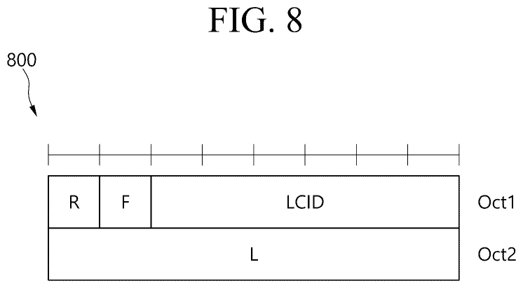

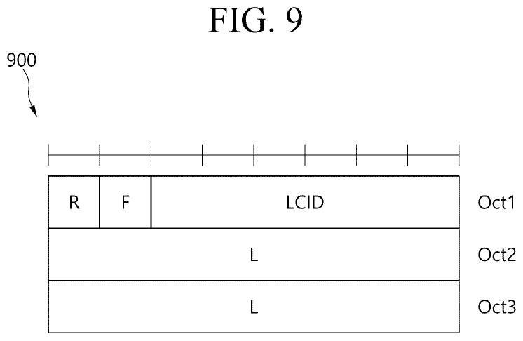

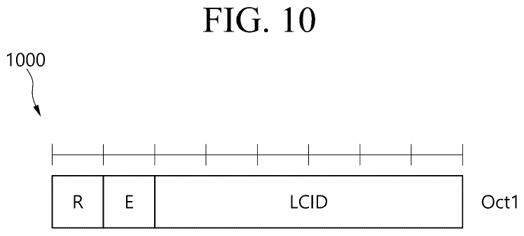

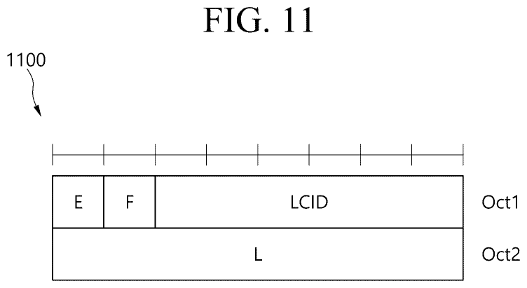

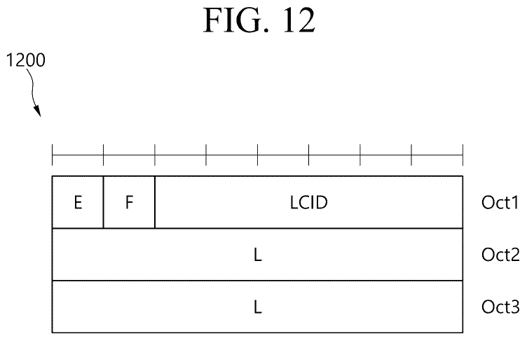

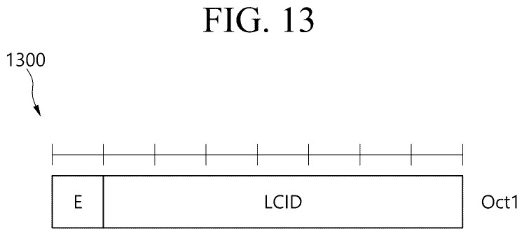

FIG. 8 is an example field of an R/F/LCID/(eLCID)/L MAC subheader 800 with an eight-bit L field. FIG. 9 is an example field 900 of an R/F/LCID/(eLCID) L MAC subheader with a 16-bit L field, accomplished by appending another octet to the subheader column. FIG. 10 is an example field 1000 of an R/E/LCID MAC subheader. FIG. 11 is an example field 1200 of an R/E/F/LCID/(eLCID) MAC subheader with an eight-bit L field. FIG. 12 is an example field 1200 of an R/E/F/LCID/(eLCID)/L MAC subheader with a 16-bit L field. Finally, FIG. 13 is an example field 1300 of an R/E/LCID MAC subheader in accordance with an embodiment.

In one embodiment, new indices of LCID, i.e. 64 to 127, are added to extend the existing Table 6.2.1-2 values of LCID for UL-SCH and/or Table 6.2.1-1 values of LCID for DL-SCH in TS 38.321 [3], cited above. Table 2 is an example of the extended table of LCIDs with indices from 64 to 127. FIGS. 10, 11, and 12 show examples of MAC subheader containing E field and 6-bit LCID field. The E field indicates whether the LCID contained in the MAC subheader is one with index from 0-63 or from 64-127. The E field set to 0 indicates LCID index from 0 to 63 and E field set to 1 indicates LCID index from 64 to 127. As an example of these embodiments, the following routine is demonstrated:

If the index of LCID is one from 64 to 127:
UE set the E field to 1 in the MAC subheader containing the LCID;
UE set 6-bit LCID field in the MAC subheader to 6 LSBs of LCID index;

Else If the index of LCID is one from 0 to 63:
UE set the E field to 0 in the MAC subheader containing the LCID.
UE set 6-bit LCID field in the MAC subheader to LCID index.

TABLE 2
Values of LCID with E bit for UL-SCH

| Codepoint | Index | LCID values |
|---|---|---|
| 0-57 | 64-121 | reserved |
| 58 | 122 | CCCH of size 48 bits (referred to as “CCCH” in TS 38.331 [2]) for a |
| | | RedCap UE indicating repetition request/capability |
| 59 | 123 | CCCH of size 64 bits (referred to as “CCCH1” in TS 38.331 [2]) for a |
| | | RedCap UE indicating repetition request/capability |
| 60 | 124 | CCCH of size 48 bits (referred to as “CCCH” in TS 38.331 [2]), except |
| | | for RedCap UE and eRedCap UE, indicating repetition |
| | | request/capability |
| 61 | 125 | CCCH of size 64 bits (referred to as “CCCH1” in TS 38.331 [2]), |
| | | except for RedCap UE and eRedCap UE, indicating repetition |
| | | request/capability |
| 62 | 126 | CCCH of size 48 bits (referred to as “CCCH” in TS 38.331 [2]) for an |
| | | eRedCap UE, indicating repetition request/capability |
| 63 | 127 | CCCH of size 64 bits (referred to as “CCCH1” in TS 38.331 [2]) for an |
| | | eRedCap UE, indicating repetition request/capability |

In another aspect, a new table of LCIDs with indexes from 0 to 63 is introduced for UL-SCH and/or a new table of LCIDs with indexes from 0 to 63 is introduced for DL-SCH. Table 3 is an example of new table of LCIDs with indexes from 0 to 63. FIGS. 10, 11, and 12 show examples of MAC subheader containing E field and 6-bit LCID field. The E field indicates whether the LCID contained in the MAC subheader is one with index from 0-63 in the exiting table(s) or in the new table. The E field set to 0 indicates LCID index from 0 to 63 in the existing table(s) and E field set to 1 indicates LCID index from 0 to 63 in the new table. The following exemplary routine is used to populate the indices.

If the index of LCID is from 0 to 63 in this new table
UE set the E field to 1 in the MAC subheader containing the LCID;
UE set 6-bit LCID field in the MAC subheader to LCID index;

If the index of LCID is one from 0 to 63 in the existing Table 6.2.1-2 Values of LCID for UL-SCH and/or Table 6.2.1-1 Values of LCID for DL-SCH in TS 38.321 [3]
UE set the E field to 0 in the MAC subheader containing the LCID.
UE set 6-bit LCID field in the MAC subheader to LCID index.

TABLE 3
Values of LCID with E bit for UL-SCH

| Codepoint | Index | LCID Values |
|---|---|---|
| 0-57 | 0-57 | reserved |
| 58 | 58 | CCCH of size 48 bits (referred to as “CCCH” in |
| | | TS 38.331 [2]) for a RedCap UE indicating |
| | | repetition request/capability |
| 59 | 59 | CCCH of size 64 bits (referred to as “CCCH1” in |
| | | TS 38.331 [2]) for a RedCap UE indicating |
| | | repetition request/capability |
| 60 | 60 | CCCH of size 48 bits (referred to as “CCCH” in |
| | | TS 38.331 [2]), except for RedCap UE and |
| | | eRedCap UE, indicating repetition |
| | | request/capability |
| 61 | 61 | CCCH of size 64 bits (referred to as “CCCH1” in |
| | | TS 38.331 [2]), except for RedCap UE and |
| | | eRedCap UE, indicating repetition |
| | | request/capability |
| 62 | 0-57 | reserved |
| 63 | 58 | CCCH of size 48 bits (referred to as “CCCH” in |
| | | TS 38.331 [2]) for a RedCap UE indicating |
| | | repetition request/capability |

In still another aspect of the disclosure, a new table of LCID with indexes from 0 to 127 is introduced for UL-SCH and/or a new table of LCIDs with indexes from 0 to 127 is introduced for DL-SCH. Table 4 is an example of the new table of LCIDs with indexes from 0 to 127. FIG. 13 shows an example of MAC subheader containing E field and 7-bit LCID field. The E field indicates whether the LCID contained in the MAC subheader is one with index from 0-63 in the exiting table(s) or in the new table with index from 0 to 127. The E field set to 0 indicates LCID index from 0 to 63 in the existing table(s) and E field set to 1 indicates LCID index from 0 to 127 in the new table.

An example routine is provided to further demonstrate these embodiment.

If the index of LCID is one from 0 to 127 in this new table:
UE set E bit to 1 in the MAC subheader containing the LCID;
UE set 7-bit LCID field to LCID index.

If the index LCID is one from 0 to 63 in the existing Table 6.2.1-2 Values of LCID for UL-SCH and/or Table 6.2.1-1 Values of LCID for DL-SCH in TS 38.321 [3]:
UE set E to 0 in the MAC subheader containing the LCID;
UE set 6 LSBs in the LCID field to LCID index.

TABLE 4
Values of LCID with E bit for UL-SCH

| Codepoint | Index | LCID values |
|---|---|---|
| 64-121 | 64-121 | reserved |
| 122 | 122 | CCCH of size 48 bits (referred to as “CCCH” in TS 38.331 [2]) for a |
| | | RedCap UE indicating repetition request/capability |
| 123 | 123 | CCCH of size 64 bits (referred to as “CCCH1” in TS 38.331 [2]) for a |
| | | RedCap UE indicating repetition request/capability |
| 124 | 124 | CCCH of size 48 bits (referred to as “CCCH” in TS 38.331 [2]), except |
| | | for RedCap UE and eRedCap UE, indicating repetition |
| | | request/capability |
| 125 | 125 | CCCH of size 64 bits (referred to as “CCCH1” in TS 38.331 [2]), |
| | | except for RedCap UE and eRedCap UE, indicating repetition |
| | | request/capability |
| 126 | 126 | CCCH of size 48 bits (referred to as “CCCH” in TS 38.331 [2]) for an |
| | | eRedCap UE, indicating repetition request/capability |
| 127 | 127 | CCCH of size 64 bits (referred to as “CCCH1” in TS 38.331 [2]) for an |
| | | eRedCap UE, indicating repetition request/capability |

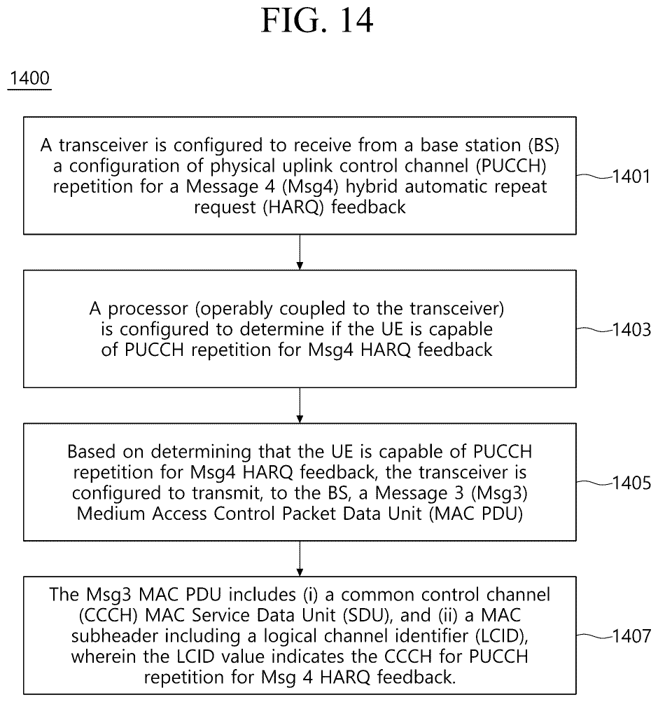

FIG. 14 is an example flow diagram 1400 of a UE capable of PUCCH repetition capability for Message 4 (Msg4) HARQ feedback, in accordance with an embodiment. The features in FIG. 14 are performed by the UE. At 1401, a transceiver in the UE is configured to receive from a base station (BS) a configuration of physical uplink control channel (PUCCH) repetition for a Message 4 (Msg4) hybrid automatic repeat request (HARQ) feedback. At 1403, a processor (operably coupled to the transceiver) is configured to determine if the UE is capable of PUCCH repetition for Msg4 HARQ feedback. Thereupon, at 1405, based on determining that the UE is capable of PUCCH repetition for Msg4 HARQ feedback, the transceiver is configured to transmit, to the BS, a Message 3 (Msg3) Medium Access Control Packet Data Unit (MAC PDU). At 1407, it is underscored that the Msg3 MAC PDU includes (i) a common control channel (CCCH) MAC Service Data Unit (SDU), and (ii) a MAC subheader including a LCID, where the value of the LCID indicates the CCCH for PUCCH repetition for Msg 4 HARQ feedback.

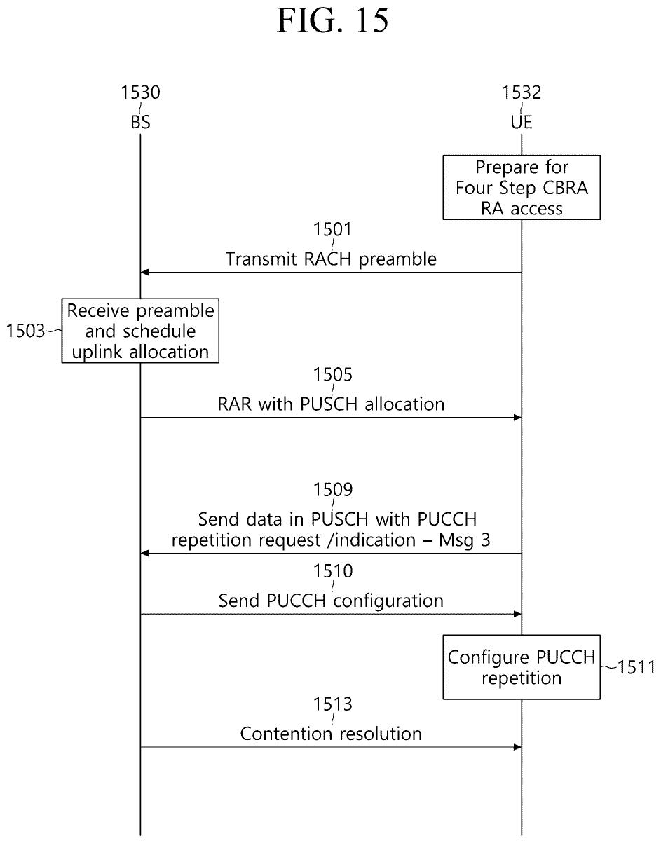

FIG. 15 is an example signaling diagram of a random access exchange between a UE and a BS, in accordance with an embodiment. Referring initially to the UE 1532, the UE is undergoing internal preparations to effectuate the four-step CBRA random access exchange. At 1501, the UE proceeds to transmit a RACH preamble to BS 1530 over a random access channel. At 1503, the BS may receive the preamble, in which case it may schedule an uplink allocation for the data that the UE intends to transmit. Using this information, the BS 1530 may at 1505 provide a random access response to the UE 1532 with an allocation on a PUSCH for the UE to send its data. Having received the allocation, the UE proceeds at 1509 to transmit data in the allocated PUSCH resources. In this case, the data may include a PUCCH repetition request indication for Msg3. The BS 1530 may thereupon proceed to send a PUCCH configuration (1510), and the UE at 1511 configures this information. At 1513, The BS may engage in contention resolution, with the UE 1532 using its HARQ repetition as necessary.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE), comprising:
a transceiver configured to receive from a base station (BS) a configuration of physical uplink control channel (PUCCH) repetition for a Message 4 (Msg4) hybrid automatic repeat request (HARQ) feedback;
a processor operably coupled to the transceiver, the processor configured to determine if the UE is capable of PUCCH repetition for Msg4 HARQ feedback;
wherein based on the determination that the UE is capable of PUCCH repetition for Msg4 HARQ feedback, the transceiver is configured to:
transmit, to the BS, a Message 3 (Msg3) Medium Access Control Packet Data Unit (MAC PDU),
wherein the Msg3 MAC PDU includes (i) a common control channel (CCCH) MAC Service Data Unit (SDU), and (ii) a MAC subheader including a logical channel identifier (LCID), wherein a value of the LCID indicates the CCCH for PUCCH repetition for Msg 4 HARQ feedback.

2. The UE of claim 1, wherein:
the configuration for PUCCH repetition for Msg4 HARQ feedback is received via a system information block (SIB), and
the configuration for PUCCH repetition for Msg4 HARQ feedback includes a reference signal received power (RSRP) threshold.

3. The UE of claim 2, wherein:
the processor is further configured to determine whether a RSRP of a downlink (DL) path loss reference signal is smaller than the RSRP threshold, and
the Msg3 MAC PDU including the value of the LCID indicating the CCCH for PUCCH repetition for Msg4 HARQ feedback is transmitted based on the determination that the RSRP of the DL path loss reference signal is smaller than the RSRP threshold.

4. The UE of claim 1, wherein the value of the LCID indicates a CCCH of size 48 bits or 64 bits for PUCCH repetition for Msg4 HARQ feedback, except for a reduced capability (RedCap) UE and an eRedCap UE.

5. The UE of claim 1, wherein the value of the LCID indicates a CCCH of size 48 bits or 64 bits for a RedCap UE for PUCCH repetition for Msg4 HARQ feedback.

6. The UE of claim 1, wherein the value of the LCID indicates a CCCH of size 48 bits or 64 bits for an eRedCap UE for PUCCH repetition for Msg4 HARQ feedback.

7. The UE of claim 1, wherein:
the MAC subheader includes a one-bit field indicating whether the value of the LCID is from a first table of LCID values or a second table of LCID values;
the field is set to 0 to indicate that the value of the LCID is from the first table; and
the field is set to 1 to indicate that the value of the LCID is from the second table.

8. The UE of claim 7, wherein the first table and the second table are each 64 bits in size.

9. A method performed by a user equipment (UE), the method comprising:
receiving from a base station (BS) a configuration of physical uplink control channel (PUCCH) repetition for a Message 4 (Msg4) hybrid automatic repeat request (HARQ) feedback;
determining if the UE is capable of PUCCH repetition for Msg4 HARQ feedback; and
transmitting to the BS, based on determining that the UE is capable of PUCCH repetition for Msg4 HARQ feedback, a Message 3 (Msg3) Medium Access Control Packet Data Unit (MAC PDU), the Msg3 MAC PDU including (i) a common control channel (CCCH) MAC Service Data Unit (SDU), and (ii) a MAC subheader including a logical channel identifier (LCID), wherein a value of the LCID indicates the CCCH for PUCCH repetition for Msg 4 HARQ feedback.

10. The method of claim 9, further comprising:
receiving the configuration for PUCCH repetition for Msg4 HARQ feedback via a system information block (SIB), and
including in the configuration for PUCCH repetition for Msg4 HARQ feedback a reference signal received power (RSRP) threshold.

11. The method of claim 10, further comprising:
determining whether a RSRP of a downlink (DL) path loss reference signal is smaller than the RSRP threshold, and
transmitting the Msg3 MAC PDU including the value of the LCID indicating the CCCH for PUCCH repetition for Msg4 HARQ feedback based on the determination that the RSRP of the DL path loss reference signal is smaller than the RSRP threshold.

12. The method of claim 9, wherein the value of the LCID indicates a CCCH of size 48 bits or 64 bits for PUCCH repetition for Msg4 HARQ feedback, except for a reduced capability (RedCap) UE and an eRedCap UE.

13. The method of claim 9, wherein the value of the LCID indicates a CCCH of size 48 bits or 64 bits for a RedCap UE for PUCCH repetition for Msg4 HARQ feedback.

14. The method of claim 9, wherein the value of the LCID indicates a CCCH of size 48 bits or 64 bits for an eRedCap UE for PUCCH repetition for Msg4 HARQ feedback.

15. The method of claim 9, further comprising:
including in the MAC subheader a one-bit field indicating whether the value of the LCID is from a first table of LCID values or a second table of LCID values;
setting the field to 0 to indicate that the value of the LCID is from the first table; and
setting the field to 1 to indicate that the value of the LCID is from the second table.

16. The method of claim 15, wherein the first table and the second table are each 64 bits in size.

17. A base station (BS), comprising:
a processor; and
a transceiver operably coupled to the processor, the transceiver configured to:
transmit, to a user equipment (UE), a configuration of physical uplink control channel (PUCCH) repetition for a Message 4 (Msg4) hybrid automatic repeat request (HARQ) feedback; and
receive, from the UE, a Message 3 (Msg3) Medium Access Control Packet Data Unit (MAC PDU),
wherein the Msg3 MAC PDU includes (i) a common control channel (CCCH) MAC Service Data Unit (SDU), and (ii) a MAC subheader including a logical channel identifier (LCID), wherein a value of the LCID indicates the CCCH for PUCCH repetition for Msg 4 HARQ feedback.

18. The BS of claim 17, wherein the transceiver is configured to receive from the UE Msg4 HARQ feedback based on the configuration of PUCCH repetition transmitted to the UE.

19. The BS of claim 17, wherein:
the processor is configured to determine the configuration for PUCCH repetition for Msg4 HARQ feedback transmitted by the transceiver to the UE.

20. The BS of claim 17 wherein:
the transceiver is configured to transmit to the UE a reference signal received power (RSRP) threshold in the configuration for PUCCH repetition for Msg4 HARQ feedback via a system information block (SIB).
